(19) United States
(12) Patent Application Publication
(10) Pub. No.: US 2008/0051965 A1
(43) Pub. Date: Feb. 28, 2008

(54) BRAKE CONTROL APPARATUS AND BRAKE CONTROL METHOD

(75) Inventor: Eiji Nakamura, Nishikamo-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/832,322

(22) Filed: Aug. 1, 2007

(30) Foreign Application Priority Data
Aug. 25, 2006 (JP) 2006-229292

(51) Int. Cl. B60T 8/00

(52) U.S. Cl. 701/70

(57) ABSTRACT

A brake control apparatus includes a master cylinder that pressurizes the hydraulic fluid in accordance with the operation amount of a brake operating member and then delivers the pressurized hydraulic fluid; a stroke simulator that generates the reaction force against the operation on the brake operating member when supplied with the hydraulic fluid delivered from the master cylinder; wheel cylinders that apply the braking force to respective wheels when supplied with the hydraulic fluid delivered from the master cylinder; and a controller that controls the manner in which the hydraulic fluid is delivered. When the destination of the hydraulic fluid from the master cylinder is changed from the stroke simulator to the wheel cylinders to start increasing the wheel cylinder pressure, the controller controls the above-mentioned manner so that the stroke simulator is used in combination with the master cylinder as a hydraulic pressure source.

### INCORPORATION BY REFERENCE

The disclosure of Japanese Patent Application No. 2006-229292 filed on Aug. 25, 2006 including the specification, drawings and abstract is incorporated herein by reference in its entirety.

### BACKGROUND OF THE INVENTION

1. Field of the Invention

The invention relates to a brake control apparatus and brake control method that controls the braking force applied to the wheels of a vehicle.

2. Description of the Related Art

Japanese Patent Application Publication No. 2005-35471 (JP-A-2005-35471) describes a hydraulic pressure control apparatus that is used to apply the braking force to the wheels of a vehicle. The hydraulic pressure control apparatus is provided with an actuator including multiple pairs of electromagnetically controlled valves respectively used to increase and decrease the pressure of the hydraulic fluid supplied to wheel cylinders provided to the wheels; and an electronic control unit that controls the actuator. With this hydraulic pressure control apparatus, the operation amount of a brake pedal is measured by, for example, a sensor, and translated into an electric signal that is transmitted to the electronic control unit. The electronic control unit controls the electromagnetically controlled valves used to increase or decrease the pressure, thereby controlling the pressures of the hydraulic fluids supplied to the wheel cylinders for the four wheels of the vehicle independently from each other in an optimum manner. Controlling the braking force based on electric signals translated from the operations executed by the driver is generally referred to as “brake by wire”. The hydraulic pressure control apparatus is provided with a stroke simulator. While the electronic control unit controls the wheel cylinder pressure, the brake oil delivered from the master cylinder in accordance with the braking operation executed by the driver flows into the stroke simulator.

In hybrid vehicles and electric vehicles, the cooperative braking control for generating a required braking force using a hydraulic braking force and a regenerative braking force in combination is sometimes executed. During the cooperative braking control, the required braking force is obtained by complementing the regenerative braking force with the hydraulic braking force. Executing the cooperative braking control improves the fuel efficiency of the vehicle. If a malfunction is detected, the cooperative braking control is stopped, and the control mode is changed so that the hydraulic fluid is supplied from the master cylinder directly to the wheel cylinders and the required braking force is derived from the hydraulic braking force. During the cooperative braking control, the hydraulic fluid in the master cylinder is supplied to the stroke simulator in accordance with the operation amount of the brake pedal. Accordingly, when the control mode is changed, the braking force is generated using the hydraulic fluid that remains in the master cylinder. To maintain sufficient fail-safe properties, even if a sufficient amount of hydraulic fluid does not remain in the master cylinder, sufficient braking force need to be obtained.

### SUMMARY OF THE INVENTION

The invention provides a brake control technology that provides improved brake performance offered when the control mode is changed.

A first aspect of the invention relates to a brake control apparatus including a master cylinder that pressurizes the hydraulic fluid in accordance with the operation amount of a brake operating member and then delivers the pressurized hydraulic fluid; a stroke simulator that generates the reaction force against the operation on the brake operating member when supplied with the hydraulic fluid delivered from the master cylinder; wheel cylinders that apply braking force to respective wheels when supplied with the hydraulic fluid delivered from the master cylinder; and a controller that controls the manner in which the hydraulic fluid is delivered. When the destination of the hydraulic fluid from the master cylinder is changed from the stroke simulator to the wheel cylinders to start increasing the wheel cylinder pressure which is the pressure of the hydraulic fluid supplied to the wheel cylinders, the controller controls the manner in which the hydraulic fluid is delivered so that the stroke simulator is used in combination with the master cylinder as a hydraulic pressure source.

In the first aspect of the invention, the controller may control the manner in which the hydraulic fluid is delivered by interrupting communication between the master cylinder and the stroke simulator after permitting communication between the master cylinder and the wheel cylinders.

According to the first aspect of the invention, when the destination of the hydraulic fluid from the master cylinder is changed from the stroke simulator to the wheel cylinders to start increasing the wheel cylinder pressure, the stroke simulator is used in combination with the master cylinder as the hydraulic pressure source. Generally, when the destination of the hydraulic fluid is changed, the stroke simulator is immediately shut off from the master cylinder, and the hydraulic fluid in the stroke simulator is not used to increase the wheel cylinder pressure. Using the stroke simulator as the hydraulic pressure source makes it possible to obtain sufficient braking force even when the amount of hydraulic fluid that remains in the master cylinder is small, for example, even when the operation amount of the brake operating member is great. Therefore, it is possible to improve the brake performance that is offered when the destination of the hydraulic fluid delivered from the master cylinder is changed.

In the first aspect of the invention, the brake control apparatus may further include a simulator cut valve that is provided in a passage which connects the master cylinder to the stroke simulator; and a master cut valve that is provided in a passage which connects the master cylinder to the wheel cylinders. The controller may open the master cut valve before closing the simulator cut valve when the destination of the hydraulic fluid from the master cylinder is changed from the stroke simulator to the wheel cylinders.

With this configuration, the simulator cut valve is provided in the passage that connects the master cylinder to the stroke simulator, and opens/closes to permit/interrupt the flow of the hydraulic flow between the master cylinder and the stroke simulator. The master cut valve is provided in the passage that connects the master cylinder to the wheel cylinders, and opens/closes to permit/interrupt the flow of the hydraulic fluid between the master cylinder and the wheel cylinders. The controller opens the master cut valve before closing the simulator cut valve, when the destination of the hydraulic fluid from the master cylinder is changed from the stroke simulator to the wheel cylinders.

Accordingly, when the destination of the hydraulic fluid delivered from the master cylinder is changed, both the master cut valve and the simulator cut valve are open during a predetermined period. Accordingly, the stroke simulator as well as the master cylinder serves as the source of the hydraulic fluid that is supplied to the wheel cylinders. Accordingly, even if the amount of hydraulic fluid that remains in the master cylinder is small, the wheel cylinder pressure can be increased by using also the hydraulic fluid stored in the stroke simulator. As a result, it is possible to improve the brake performance that is offered when the destination of the hydraulic fluid delivered from the master cylinder is changed.

The controller may control the manner in which the hydraulic fluid is delivered so that the stroke simulator is used as the hydraulic pressure source, when the master cylinder pressure is higher than the wheel cylinder pressure. During the cooperative braking control, the master cylinder pressure is usually higher than the wheel cylinder pressure by an amount corresponding to the regenerative braking force. Also, when the hydraulic fluid leaks or the pressure-decreasing valve is inappropriately kept open and, therefore, the wheel cylinder pressure decreases, the master cylinder pressure is higher than the wheel cylinder pressure. When the hydraulic fluid is delivered from the master cylinder to the stroke simulator, the master cylinder pressure is equal to the stroke simulator pressure. Accordingly, both the stroke simulator pressure and the master cylinder pressure are higher than the wheel cylinder pressure. Therefore, it is possible to supply the hydraulic fluid to the wheel cylinders also from the stroke simulator due to the difference between the stroke simulator pressure and the wheel cylinder pressure. Accordingly, a sufficient amount of braking force is obtained by using the stroke simulator in combination of the master cylinder as the hydraulic pressure source. As a result, it is possible to improve the brake performance offered when the destination of the hydraulic fluid delivered from the master cylinder is changed. When the master cylinder pressure is equal to or lower than the wheel cylinder pressure, the controller may close the simulator cut valve and open the master cut valve to complete the change of the destination of the hydraulic fluid delivered from the master cylinder.

When it is estimated that the predetermined brake performance cannot be offered even if the hydraulic fluid that remains in the master cylinder is supplied to the wheel cylinders, the controller may control the manner in which the hydraulic fluid is delivered so that the stroke simulator is used in combination with the master cylinder as the hydraulic pressure source. When it is estimated that the predetermined brake performance cannot be offered even if the hydraulic fluid that remains in the master cylinder is supplied to the wheel cylinders, the hydraulic fluid needs to be supplied from any one of the hydraulic pressure sources to the wheel cylinders to maintain the fail-safe properties. Conventionally, when the control mode is changed, the stroke simulator is promptly shut off to complete the change. According to the aspect described above, the stroke simulator is used as the hydraulic pressure source only when the necessity to use the stroke simulator as the hydraulic pressure source is high. This is favorable to maintain the sufficient fail-safe properties. When it is estimated that the predetermined brake performance is offered if the hydraulic fluid that remains in the master cylinder is supplied to the wheel cylinders, the controller may close the simulator cut valve and open the master cut valve to complete the change of the destination of the hydraulic fluid delivered from the master cylinder.

In the first aspect of the invention, the controller may open the master cut valve with the simulator cut valve kept open when a predetermined condition is satisfied, and the controller may keep the simulator cut valve open as long as the predetermined condition is satisfied. The predetermined condition may be a condition that the master cylinder pressure is higher than the wheel cylinder pressure. With this configuration, when the predetermined condition is satisfied, for example, when the master cylinder pressure is higher than the wheel cylinder pressure or when it is estimated that the required brake performance cannot be offered with the hydraulic fluid that remains in the master cylinder, the controller opens the master cut valve with the simulator cut valve kept open. As long as the condition is satisfied, the controller keeps the simulator cut valve open. Thus, it is possible to obtain the sufficient braking force by effectively using the hydraulic fluid that is stored in the stroke simulator.

In the first aspect of the invention, the simulator cut valve may be a normally closed electromagnetically controlled valve that is reliably kept open by the electromagnetic force which is generated when the simulator cut valve is supplied with the control current having a prescribed magnitude, and that is closed while the simulator cut valve is not supplied with the control current. The controller may supply the medium current having a smaller magnitude than the control current to the simulator cut valve when the master cut valve is opened. With this configuration, appropriately setting the magnitude of the medium current makes it possible to automatically close the simulator cut valve when the pressure difference between the upstream side and the downstream side of the simulator cut valve is decreased to the predetermined pressure corresponding to the medium current. This configuration is favorably employed, because the stroke simulator pressure is effectively used through a simple control for reducing the magnitude of the control current to the simulator cut valve to the magnitude of the medium current.

In the first aspect of the invention, the controller may set the magnitude of the medium current so that the simulator cut valve is closed when the pressure difference between the upstream side and the downstream side of the simulator cut valve is zero. Thus, the simulator cut valve is automatically closed when the master cylinder pressure is equal to the stroke simulator pressure. With this configuration, it is possible to effectively use the stroke simulator pressure through the simple control for reducing the magnitude of the control current to the simulator pressure to the magnitude of the medium current.

In the first aspect of the invention, the controller may close the simulator cut valve when the predetermined time period has elapsed since the master cut valve is opened. With this configuration, appropriately setting the predetermined time period makes it possible to effectively use the hydraulic fluid stored in the stroke simulator. In addition, it is possible to promptly close the simulator cut valve after the predetermined time period has elapsed, thereby promptly completing the change of the destination of the hydraulic fluid from the master cylinder. When priority is given to the prompt change, this configuration is favorably employed.

A second aspect of the invention relates to a brake control method. In the brake control method, a master cylinder, a stroke simulator and wheel cylinders are provided. The master cylinder pressurizes a hydraulic fluid in accordance with an operation amount of a brake operating member and then delivers the pressurized hydraulic fluid. The stroke simulator generates a reaction force against an operation on the brake operating member when supplied with the hydraulic fluid delivered from the master cylinder. The wheel cylinders apply braking force to respective wheels when supplied with the hydraulic fluid delivered from the master cylinder. When a destination of the hydraulic fluid from the master cylinder is changed from the stroke simulator to the wheel cylinders to start increasing a wheel cylinder pressure which is a pressure of the hydraulic fluid supplied to the wheel cylinders, a manner in which the hydraulic fluid is delivered is controlled so that the stroke simulator is used in combination with the master cylinder as a hydraulic pressure source.

According to the aspects described above, it is possible to provide the improved brake performance that is offered when the control mode is changed.

### BRIEF DESCRIPTION OF THE DRAWINGS

The forgoing and further objects, features and advantages of the invention will become apparent from the following description of an example embodiment with reference to the accompanying drawings, wherein the same or corresponding portions will be denoted by the same reference numerals and wherein:

FIG. 1 is the system diagram showing a brake control apparatus according to an embodiment of the invention;

FIG. 2 is the flowchart for describing an example of the routine executed when the control mode is changed to the static pressure mode according to the embodiment of the invention;

FIG. 3 is the flowchart for describing an example of the routine executed when the control mode is changed to the static pressure mode according to a modified example of the embodiment of the invention; and

FIG. 4 is the flowchart for describing an example of the routine executed when the control mode is changed to the static pressure mode according to another modified example of the embodiment of the invention.

### DETAILED DESCRIPTION OF THE EMBODIMENTS

Hereafter, an example embodiment of the invention will be described with reference to the accompanying drawings.

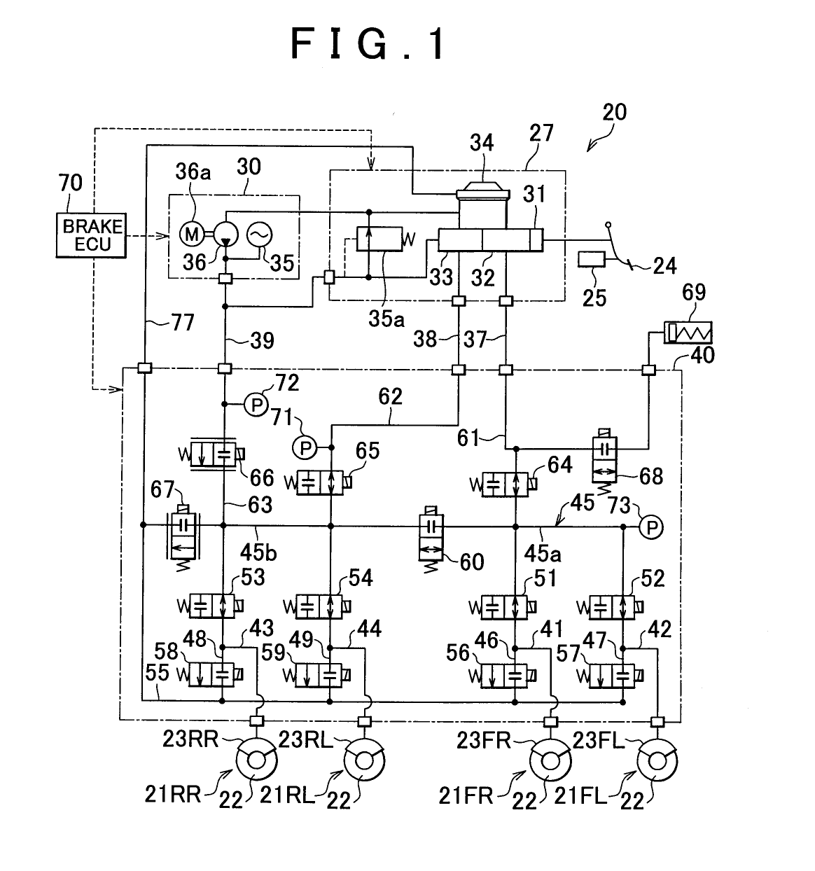

FIG. 1 is the system diagram showing a brake control apparatus 20 according to an embodiment of the invention. The brake control apparatus 20 shown in FIG. 1 forms an electronically controlled brake (ECB) system for a vehicle, and controls the braking force applied to four wheels of a vehicle. The brake control apparatus 20 according to the embodiment of the invention is mounted on, for example, a hybrid vehicle provided with an electric motor and an internal combustion engine that serve as driving power sources. In a hybrid vehicle, braking force may be applied to the vehicle through a regenerative braking operation in which the kinetic energy of the vehicle is converted into electric energy and stored or a hydraulic pressure braking operation executed by the brake control apparatus 20. In the vehicle in the embodiment of the invention, it is also possible to execute a cooperative braking control to generate the desired braking force through combined execution of the regenerative braking operation and the hydraulic pressure braking operation.

As shown in FIG. 1, the brake control apparatus 20 includes disc brake units 21 FR, 21 FL, 21 RR and 21 RL that are provided at respective four wheels, a master cylinder unit 27, a power hydraulic pressure source 30, and a hydraulic actuator 40

The disc brake units 21 FR, 21 FL, 21 RR and 21 RL apply braking force to the right front wheel, the left front wheel, the right rear wheel and the left rear wheel of the vehicle, respectively. The master cylinder unit 27, which serves as a manual hydraulic pressure source, delivers the brake fluid pressurized in accordance with the operation amount of a brake pedal 24 that serves as a brake operating member to the disc brake units 21 FR, 21 FL, 21 RR and 21 RL. The power hydraulic pressure source 30 delivers the brake fluid, used as the hydraulic fluid, pressurized due to a power supply, to the disc brake units 21 FR, 21 FL, 21 RR and 21 RL independently of any operations of the brake pedal 24. The hydraulic actuator 40 appropriately adjusts the hydraulic pressure of the brake fluid supplied from the power hydraulic pressure source 30 or the master cylinder unit 27, and then delivers the brake fluid to the disc brake units 21 FR, 21 FL, 21 RR and 21 RL. Thus, the braking force applied to each wheel through the hydraulic pressure braking operation is adjusted.

The disc brake units 21 FR, 21 FL, 21 RR and 21 RL, the master cylinder unit 27, the power hydraulic pressure source 30, and the hydraulic actuator 40 will be described below in more detail. The disc brake units 21 FR, 21 FL, 21 RR and 21 RL include brake discs 22, and wheel cylinders 23 FR, 23 FL, 23 RR and 23 RL incorporated in brake calipers, respectively. The wheel cylinders 23 FR to 23 RL are connected to the hydraulic actuator 40 via respective fluid passages. Hereinafter, the wheel cylinders 23 FR to 23 RL will be collectively referred to as the “wheel cylinders 23”.

In the disc brake units 21 FR, 21 FL, 21 RR and 21 RL, when the brake fluid is supplied from the hydraulic actuator 40 to the wheel cylinders 23, brake pads that serve as friction members are pressed to the brake discs 22 that rotate together with the wheels. Thus, braking force is applied to each wheel. In the embodiment of the invention, the disc brake units 21 FR to 21 RL are used. Alternatively, other braking force applying mechanisms including the wheel cylinders 23, for example, a drum brake unit may be used.

In the embodiment of the invention, the master cylinder unit 27 is provided with a hydraulic pressure booster. The master cylinder unit 27 includes a hydraulic pressure booster 31, a master cylinder 32, a regulator 33, and a reservoir 34. The hydraulic pressure booster 31 is connected to the brake pedal 24. The hydraulic pressure booster 31 amplifies the pedal depression force applied to the brake pedal 24, and then transfers the amplified pedal depression force to the master cylinders 32. The pedal depression force is amplified by supplying the brake fluid from the power hydraulic pressure source 30 to the hydraulic pressure booster 31 through the regulator 33. Then, the master cylinder 32 generates the master cylinder pressure corresponding to the value obtained by amplifying the pedal depression force by predetermined number of times.

The reservoir 34 that stores the brake fluid is provided above the master cylinder 32 and the regulator 33. The master cylinder 32 communicates with the reservoir 34 when the brake pedal 24 is not depressed. The regulator 33 communicates with both the reservoir 34 and an accumulator 35 of the power hydraulic pressure source 30. The regulator 33 generates the fluid pressure substantially equal to the master cylinder pressure using the reservoir 34 as a low-pressure source and the accumulator 35 as a high-pressure source. Hereinafter, the hydraulic pressure in the regulator 33 will be referred to as the “regulator pressure”. The master cylinder pressure need not be exactly equal to the regulator pressure. For example, the master cylinder 27 may be designed so that the regulator pressure is slightly higher than the master cylinder pressure.

The power hydraulic pressure source 30 includes the accumulator 35 and a pump 36. The accumulator 35 converts the pressure energy of the brake fluid pressurized by the pump 36 into the pressure energy of the filler gas such as nitrogen, for example, the pressure energy having a pressure of approximately 14 to 22 MPa, and stores the pressure energy. The pump 36 has a motor 36a that serves as a driving power source. The inlet of the pump 36 is connected to the reservoir 34, and the outlet thereof is connected to the accumulator 35. The accumulator 35 is connected also to a relief valve 35a provided in the master cylinder unit 27. When the pressure of the brake fluid in the accumulator 35 abnormally increases and becomes, for example, approximately 25 MPa, the relief valve 35a opens, and the brake fluid having a high pressure is returned to the reservoir 34.

As described above, the brake control apparatus 20 includes the master cylinder 32, the regulator 33, and the accumulator 35 that serve as brake fluid supply sources from which the brake fluid is supplied to the wheel cylinders 23. A master pipe 37 is connected to the master cylinder 32. A regulator pipe 38 is connected to the regulator 33. An accumulator pipe 39 is connected to the accumulator 35. The master pipe 37, the regulator pipe 38 and the accumulator pipe 39 are connected to the hydraulic actuator 40.

The hydraulic actuator 40 includes an actuator block having a plurality of passages formed therein, and a plurality of electromagnetically controlled valves. Examples of the passages formed in the actuator block include individual passages 41, 42, 43 and 44 and a main passage 45. The individual passages 41, 42, 43 and 44 each branch off from the main passage 45, and are connected to the wheel cylinders 23 FR, 23 FL, 23 RR and 23 RL of the disc brake units 21 FR, 21 FL, 21 RR and 21 RL, respectively. Thus, communication is provided between the wheel cylinders 23 and the main passage 45.

ABS maintaining valves 51, 52, 53 and 54 are provided at the middle portions of the individual passages 41, 42, 43 and 44, respectively. Each of the ABS maintaining valves 51, 52, 53 and 54 includes a solenoid subjected to the ON/OFF control and a spring, and is a normally open electromagnetically controlled valve that is open when electric power is not supplied to the solenoid. Each of the ABS maintaining valves 51 to 54 allows the brake fluid to flow in either direction, when it is open. Namely, each of the ABS maintaining valves 51 to 54 allows the brake fluid to flow from the main passage 45 to the wheel cylinders 23, and also allows the brake fluid to flow from the wheel cylinders 23 to the main passage 45. When electric power is supplied to the solenoids and the ABS maintaining valves 51 to 54 are closed, the flow of the brake fluid through the individual passages 41 to 44 is interrupted.

In addition, the wheel cylinders 23 are connected to a reservoir passage 55 via pressure-decreasing passages 46, 47, 48 and 49 connected to the individual passages 41, 42, 43 and 44, respectively. ABS pressure-decreasing valves 56, 57, 58 and 59 are provided at the middle portions of the pressure-decreasing passages 46, 47, 48 and 49, respectively. Each of the ABS pressure-decreasing valves 56 to 59 includes a solenoid subjected to the ON/OFF control and a spring, and is a normally closed electromagnetically controlled valve that is closed when electric power is not supplied to the solenoid. When the ABS pressure-decreasing valves 56 to 59 are closed, the flow of the brake fluid through the pressure-decreasing passages 46 to 49 is interrupted. When electric power is supplied to the solenoids and the ABS pressure-decreasing valves 56 to 59 are opened, the brake fluid flows through the pressure-decreasing passages 46 to 49, and the brake fluid is returned from the wheel cylinders 23 to the reservoir 34 through the pressure-decreasing passages 46 to 49 and the reservoir passage 55. The reservoir passage 55 is connected to the reservoir 34 of the master cylinder unit 27 via a reservoir pipe 77.

A partition valve 60 is provided at the middle portion of the main passage 45. The main passage 45 is partitioned into a first passage 45a connected to the individual passages 41 and 42, and a second passage 45b connected to the individual passages 43 and 44, when the partition valve 60 is closed. The first passage 45a is connected to the wheel cylinders 23 FR and the 23 FL for the front wheels via the individual passages 41 and 42, respectively. The second passage 45b is connected to the wheel cylinders 23 RR and 23 RL for the rear wheels via the individual passages 43 and 44, respectively.

The partition valve 60 includes a solenoid subjected to the ON/OFF control and a spring, and is a normally closed electromagnetically controlled valve. When the partition valve 60 is closed, the flow of the brake fluid through the main passage 45 is interrupted. When electric power is supplied to the solenoid and the partition valve 60 is opened, the brake fluid flows between the first passage 45a and the second passage 45b in either direction.

In the hydraulic actuator 40, a master passage 61 and a regulator passage 62 that communicate with the main passage 45 are formed. More specifically, the master passage 61 is connected to the first passage 45a of the main passage 45, and the regulator passage 62 is connected to the second passage 45b of the main passage 45. The master passage 61 is connected to the master pipe 37 that communicates with the master cylinder 32. The regulator passage 62 is connected to the regulator pipe 38 that communicates with the regulator 33.

A master cut valve 64 is provided at the middle portion of the master passage 61. The master cut valve 64 is provided on the path through which the brake fluid is supplied from the master cylinder 32 to the wheel cylinders 23. The master cut valve 64 includes a solenoid subjected to the ON/OFF control and a spring, and is a normally open electromagnetically controlled valve that is reliably kept closed by the electromagnetic force that is generated by the solenoid when a control current having a prescribed magnitude is supplied to the solenoid, and that is open when electric power is not supplied to the solenoid. When the master cut valve 64 is open, the brake fluid flows between the master cylinder 32 and the first passage 45a of the main passage 45 in either direction. When the control current having the prescribed magnitude is supplied to the solenoid and the master cut valve 64 is closed, the flow of the brake fluid through the master passage 61 is interrupted.

A stroke simulator 69 is connected to the master passage 61 via a simulator cut valve 68, at a position upstream of the master cut valve 64. Namely, the simulator cut valve 68 is provided on the passage that connects the master cylinder 32 to the stroke simulator 69. The simulator cut valve 68 includes a solenoid subjected to the ON/OFF control and a spring, and is a normally closed electromagnetically controlled valve. When the simulator cut valve 68 is closed, the flow of the brake fluid through the master passage 61 between the simulator cut valve 68 and the stroke simulator 69 is interrupted. When electric power is supplied to the solenoid and the simulator cut valve 68 is opened, the brake fluid flows between the master cylinder 32 and the stroke simulator 69 in either direction.

The stroke simulator 69 includes a plurality of pistons and a plurality of springs. When simulator cut valve 68 is opened, the stroke simulator 69 generates a reaction force in accordance with the depression force applied to the brake pedal 24. Preferably, a stroke simulator that has multi-stage spring characteristics is used as the stroke simulator 69 in order to improve the brake pedal operating feel felt by the driver.

A regulator cut valve 65 is provided at the middle portion of the regulator passage 62. The regulator cut valve 65 is provided on the path through which the brake fluid is supplied from the regulator 33 to the wheel cylinders 23. The regulator cut valve 65 also includes a solenoid subjected to the ON/OFF control and a spring, and is a normally open electromagnetically controlled valve. When the regulator cut valve 65 is open, the brake fluid flows between the regulator 33 and the second passage 45b of the main passage 45 in either direction. When electric power is supplied to the solenoid and the regulator cut valve 65 is closed, the flow of the brake fluid through the regulator passage 62 is interrupted.

In addition to the master passage 61 and the regulator passage 62, an accumulator passage 63 is formed in the hydraulic actuator 40. One end of the accumulator passage 63 is connected to the second passage 45b of the main passage 45, and the other end thereof is connected to the accumulator pipe 39 that communicates with the accumulator 35.

A pressure-increasing linear control valve 66 is provided at the middle portion of the accumulator passage 63. The accumulator passage 63 and the second passage 45b of the main passage 45 are connected to the reservoir passage 55 via a pressure-decreasing linear control valve 67. Each of the pressure-increasing linear control valve 66 and the pressure-decreasing linear control valve 67 has a linear solenoid and a spring, and is a normally closed electromagnetically controlled valve. The opening amounts of the pressure-increasing linear control valve 66 and the pressure-decreasing control valve 67 are adjusted in proportion to the magnitudes of electric currents supplied to the respective linear solenoids.

The pressure-increasing linear control valve 66 is shared by the multiple wheel cylinders 23 corresponding to the respective wheels. Similarly, the pressure-decreasing linear control valve 67 is also shared by the multiple wheel cylinders 23. Namely, according to the embodiment of the invention, the pressure-increasing linear control valve 66 and the pressure-decreasing linear control valve 67 are provided as a pair of control valves that are shared by the wheel cylinders 23 and that control the hydraulic fluid supplied from the power hydraulic pressure source 30 to the wheel cylinders 23 and the hydraulic fluid returned from the wheel cylinders 23 to the power hydraulic pressure source 30. If the pressure-increasing linear control valve 66, etc. are shared by the wheel cylinders 23 as described above, the cost performance is better than that when the wheel cylinders 23 are provided with respective linear control valves.

The pressure difference between the inlet and the outlet of the pressure-increasing linear control valve 66 corresponds to the difference between the pressure of the brake fluid in the accumulator 35 and the pressure of the brake fluid in the main passage 45. The pressure difference between the inlet and the outlet of the pressure-decreasing linear control valve 67 corresponds to the difference between the pressure of the brake fluid in the main passage 45 and the pressure of the brake fluid in the reservoir 34. When the electromagnetic driving force corresponding to the electric power supplied to the linear solenoid of each of the pressure-increasing linear control valve 66 and the pressure-decreasing linear control valve 67 is F1, the biasing force of the spring of each of the pressure-increasing linear control valve 66 and the pressure-decreasing linear control valve 67 is F2, and the differential pressure acting force corresponding to the pressure difference between the inlet and the outlet of each of the pressure-increasing linear control valve 66 and the pressure-decreasing linear control valve 67 is F3, the equation, F1+F3=F2, is satisfied. Accordingly, the pressure difference between the inlet and the outlet of each of the pressure-increasing linear control valve 66 and the pressure-decreasing linear control valve 67 is controlled by continuously controlling the electric power supplied to the linear solenoid of each of the pressure-increasing linear control valve 66 and the pressure-decreasing linear control valve 67.

In the brake control apparatus 20, the power hydraulic pressure source 30 and the hydraulic actuator 40 are controlled by a brake ECU 70 that serves as a controller according to the embodiment of the invention. The brake ECU 70 is formed of a microprocessor including a CPU. The brake ECU 70 includes, in addition to the CPU, ROM that stores various programs, RAM that temporarily stores data, an input port, an output port, a communication port, etc. The brake ECU 70 communicates with a hybrid ECU (not shown), etc. at a higher level. The brake ECU 70 controls the pump 36 of the power hydraulic pressure source 30, the electromagnetically controlled valves 51 to 54, 56 to 59, and 64 to 68 that form the hydraulic actuator 40 based on the control signals from the hybrid ECU and the signals from various sensors.

A regulator pressure sensor 71, an accumulator pressure sensor 72, and a control pressure sensor 73 are connected to the brake ECU 70. The regulator pressure sensor 71 is provided upstream of the regulator cut valve 65. The regulator pressure sensor 71 detects the pressure of the brake fluid in the regulator passage 62, namely, the regulator pressure, and transmits a signal indicating the detected regulator pressure to the brake ECU 70. The accumulator pressure sensor 72 is provided upstream of the pressure-increasing linear control valve 66. The accumulator pressure sensor 72 detects the pressure of the brake fluid in the accumulator passage 63, namely, the accumulator pressure, and transmits a signal indicating the detected accumulator pressure to the brake ECU 70. The control pressure sensor 73 detects the pressure of the brake fluid in the first passage 45a of the main passage 45, and transmits a signal indicating the detected brake fluid pressure to the brake ECU 70. The signals indicating the values detected by the pressure sensors 71 to 73 are transmitted to the braked ECU 70 at predetermined time intervals, and stored in a predetermined storage region of the brake ECU 70.

When the partition valve 60 is open and the first passage 45a and the second passage 45b of the main passage 45 communicate with each other, the value output from the control pressure sensor 73 indicates the lower hydraulic pressure at the pressure-increasing linear control valve 66 and the higher hydraulic pressure at the pressure-decreasing linear control valve 67. Accordingly, the value output from the control pressure sensor 73 is used to control the pressure-increasing linear control valve 66 and the pressure-decreasing linear control valve 67. When the pressure-increasing linear control valve 66 and the pressure-decreasing linear control valve 67 are both closed and the master cut valve 64 is open, the value output from the control pressure sensor 73 indicates the master cylinder pressure. When the partition valve 60 is open and the first passage 45a and the second passage 45b of the main passage 45 communicate with each other, and the ABS maintaining valves 51 to 54 are open while the ABS pressure-decreasing valves 56 to 59 are closed, the value output from the control pressure sensor 73 indicates the hydraulic fluid pressure that is applied to each of the wheel cylinders 23, namely, the wheel cylinder pressure.

Examples of the sensors connected to the brake ECU 70 include a stroke sensor 25 provided at the brake pedal 24. The stroke sensor 25 detects the brake pedal stroke that is the operation amount of the brake pedal 24, and transmits a signal indicating the detected brake pedal stroke to the brake ECU 70. The value output from the stroke sensor 25 is transmitted to the brake ECU 70 at predetermined time intervals, and stored in a predetermined storage region of the brake ECU 70. Brake pedal operation detection means other than the stroke sensor 25 may be provided in addition to or instead of the stroke sensor 25, and connected to the brake ECU 70. Examples of the brake pedal operation detection means include a pedal depression force sensor that detects the operation force applied to the brake pedal 24, and a brake switch that detects depression of the brake pedal 24.

The brake control apparatus 20 configured in the above-described manner executes the cooperative braking control. The brake control apparatus 20 starts the braking control in response to an instruction to start the braking operation (hereinafter, referred to as a “braking instruction”). Such braking instruction is issued when braking force needs to be applied to the vehicle, for example, when the brake pedal 24 is operated. The brake ECU 70 calculates a required hydraulic pressure braking force in response to the braking instruction. The brake ECU 70 calculates the required hydraulic pressure braking force, that is, the braking force that needs to be generated by the brake control apparatus 20, by subtracting the regenerative braking force from the required braking force. A signal indicating the regenerative braking force is transmitted from the hybrid ECU to the brake control apparatus 20. The brake ECU 70 then calculates the target hydraulic pressure for each of the wheel cylinders 23 FR to 23 RL based on the calculated required hydraulic pressure braking force. The brake ECU 70 determines the values of the currents that are supplied to the pressure-increasing linear control valve 66 and the pressure-decreasing linear control valve 67 according to the feedback control law so that the wheel cylinder pressure reaches the target hydraulic pressure.

As a result, in the brake control apparatus 20, the brake fluid is supplied from the power hydraulic pressure source 30 to each wheel cylinders 23 through the pressure-increasing linear control valve 66, whereby braking force is applied to each wheel. Also, the brake fluid is discharged from each wheel cylinders 23 through the pressure-decreasing linear control valve 67 when needed, whereby the braking force applied to each wheel is adjusted. According to the embodiment of the invention, a wheel cylinder pressure control system is formed of the power hydraulic pressure source 30, the pressure-increasing linear control valve 66, the pressure-decreasing linear control valve 67, etc. The wheel cylinder pressure control system executes the braking force control through so-called brake-by-wire. The wheel cylinder pressure control system is provided parallel to the path through which the brake fluid is supplied from the master cylinder unit 27 to the wheel cylinders 23.

When the braking force control is executed, the brake ECU 70 closes the regulator cut valve 65 so that the brake fluid delivered from the regulator 33 is not supplied to the wheel cylinders 23. In addition, the brake ECU 70 closes the master cut valve 64, and opens the simulator cut valve 68. Such control is executed so that the brake fluid, delivered from the master cylinder 32 in response to the operation of the brake pedal 24, is supplied not to the wheel cylinders 23 but to the stroke simulator 69. During the cooperative braking control, the pressure difference between the upstream side and the downstream side of each of the regulator cut valve 65 and the master cut valve 64 corresponds to the magnitude of the regenerative braking force.

In the brake control apparatus 20 according to the embodiment of the invention, even when the required braking force is derived only from the hydraulic braking force without using any regenerative braking force, the braking force can be controlled by the wheel cylinder pressure control system. Hereinafter, regardless of whether the brake operating member is executed, the control mode in which the braking force is controlled by the wheel cylinder pressure control system will be referred to as the “linear control mode” where appropriate. Alternatively, such control mode will be sometimes referred to as the control through brake-by-wire.

During the control executed in the liner control mode, the wheel cylinder pressure may deviate from the target hydraulic pressure due to, for example, a decrease in the wheel cylinder pressure caused by occurrence of a malfunction, for example, a failure. The brake ECU 70 periodically determines whether the wheel cylinder pressure appropriately responds to the control based on, for example, the control pressure detected by the control pressure sensor 73. If it is determined that the wheel cylinder pressure does not appropriately respond to the control, the brake ECU 70 stops the linear control mode and changes the control mode to the manual brake mode. In the manual brake mode, the operation amount of the brake pedal 24 changes the hydraulic pressure, and then mechanically transferred to the wheel cylinders 23, whereby the braking force is applied to the wheels. The manual brake mode serves as a fail-safe for the linear control mode.

The brake ECU 70 selects the manual brake mode from among multiple modes by selecting the one supply path from among multiple supply paths through which the hydraulic fluid is supplied from the hydraulic pressure source to the wheel cylinders 23. In the embodiment of the invention, changing the control mode to the non-control mode will be described as an example. In the non-control mode, the brake ECU 70 stops the supply of the control current to all the electromagnetically controlled valves. Thus, the normally open master cut valve 64 and the regulator cut valve 65 are opened, and the normally-closed partition valve 60 and the simulator cut valve 68 are closed. The supply of the control current to the pressure-increasing linear control valve 66 and the pressure-decreasing linear control valve 67 is stopped, whereby these valves 66 and 67 are closed.

As a result, the brake fluid supply path is partitioned into two systems, that is, the system on the master cylinder side and the system on the regulator side. Then, the master cylinder pressure is transferred to the wheel cylinders 23 FR and 23 FL for the front wheels, and the regulator pressure is transferred to the wheel cylinders 23 RR and 23 RL for the rear wheels. The destination of the hydraulic fluid from the master cylinder 32 is changed from the stroke simulator 69 to the wheel cylinders 23 FR and 23 FL for the front wheels. Executing the non-control mode makes it possible to generate the braking force even if the electric power is not supplied to the electromagnetically controlled valves due to a malfunction in the control system. Accordingly, the configuration described above provides sufficient fail-safe properties.

If the control mode is changed from the linear control mode to the non-control mode when a malfunction is detected, the braking force that is applied to the front wheels needs to be generated using the brake fluid that remains in the master cylinder. At this time, the amount of the brake fluid that remains in the master cylinder may be small, because the brake fluid has been already delivered from the master cylinder 32 to the stroke simulator 69 in accordance with the brake pedal depression amount. Also, the wheel cylinder pressure is lower than the master cylinder pressure by an amount corresponding to the regenerative braking force, during the cooperative braking control. Especially, when the required braking force is derived only from the regenerative braking force, the hydraulic braking force is equal to zero, namely, the wheel cylinder pressure is zero (i.e., equal to the atmospheric pressure). Even when the cooperative braking control is not executed, the wheel cylinder pressure may be decreased due to malfunctions. Namely, the wheel cylinder pressure may be decreased, for example, when the pressure-decreasing linear control valve 67 or the ABS pressure-decreasing valve 58 or 59 is inappropriately kept open or the brake fluid leaks from the pipe.

When a malfunction is detected during the control through brake-by-wire, the amount of the hydraulic fluid that remains in the master cylinder 32 may be relatively small, and the wheel cylinder pressure may be relatively low. If the control mode is changed to the non-control mode and a sufficient braking force needs to be obtained in this state, for example, a large master cylinder may be employed as the master cylinder 32 to leave a large amount of hydraulic fluid in the master cylinder 32. However, this increases the size of the brake control apparatus. Alternatively, a small stroke simulator may be employed as the stroke simulator 69 to reduce the amount of hydraulic fluid delivered from the master cylinder 32. However, it is not easy to provide the driver with good braking feel with such small stroke simulator 69.

Therefore, in the brake control apparatus 20 according the embodiment of the invention, when the control mode is changed to the static pressure mode such as the non-control mode described above, the stroke simulator 69 is used as the hydraulic pressure source in combination with the master cylinder 32 in a predetermined condition. Thus, it is possible to improve the brake performance offered when the control mode is changed due to occurrence of a malfunction while providing the driver with good braking feel, without an increase in the size of the brake control apparatus and a cost increase. In this specification, the static pressure mode means the control mode in which the braking force is generated by supplying the brake fluid from the master cylinder 32 to at least one of the multiple wheel cylinders 23. Hereafter, the control mode such as the liner control mode, in which the wheel cylinder pressure is controlled by the brake fluid from the power hydraulic pressure source 30, will be sometimes referred to as the dynamic control mode, in contrast with the static pressure mode.

The brake ECU 70 controls the manner in which the brake fluid is delivered so that the stroke simulator 69 is used as the hydraulic pressure source in combination with the master cylinder 32 when the destination of the brake fluid from the master cylinder 32 is changed from the stroke simulator 69 to the wheel cylinders 23. More specifically, when the control mode is changed to the static pressure mode, the brake ECU 70 opens the master cut valve 64 before closing the simulator cut valve 68. During the period from when the master cut valve 64 is opened until when the simulator cut valve 68 is closed, both the master cut valve 64 and the simulator cut valve 68 are open. Therefore, in addition to the master cylinder 32, the stroke simulator 69 also serves as the supply source of the brake fluid that is supplied to the wheel cylinders 23. The control, in which the master cut valve 64 is opened before closing the simulator cut valve 68 when the control mode is changed to the static pressure mode, will be referred to as the SMC initially opening control, where appropriate. For convenience, the master cut valve 64 and the simulator cut valve 68 will be referred to as the SMC 64 and the SSC 68, respectively, where appropriate.

In a typical brake control apparatus, the destination of the brake fluid from the master cylinder 32 is the wheel cylinders 23 or the stroke simulator 69. The wheel cylinders 23 and the stroke simulator 69 are not supplied with the brake fluid from the master cylinder 32 concurrently. Namely, while the brake fluid is supplied from the master cylinder 32 to the wheel cylinders 23, the brake fluid is not supplied to the stroke simulator 69. On the other hand, while the brake fluid is supplied from the master cylinder 32 to the stroke simulator 69, the brake fluid is not supplied to the wheel cylinders 23. This is because the basic function of the stroke simulator 69 is to offer good braking feel by generating a reaction force during the control through brake-by-wire, in place of the wheel cylinders 23. Accordingly, using the stroke simulator as one of the hydraulic pressure sources and permitting communication between the stroke simulator 69 and the wheel cylinders 23 are the distinctive features of the embodiment of the invention.

In the embodiment of the invention, the brake ECU 70 executes the SMC initially opening control under a predetermined condition, for example, when it is estimated that the master cylinder pressure is higher than the wheel cylinder pressure. In the dynamic pressure control mode, because the simulator cut valve 68 is opened and the master cylinder 32 is communicated with the stroke simulator 69, the master cylinder pressure is equal to the stroke simulator pressure. Accordingly, when the master cylinder pressure is higher than the wheel cylinder pressure, the stroke simulator pressure is also higher than the wheel cylinder pressure. Therefore, it is possible to improve the brake performance offered when the control mode is changed to the static pressure mode, by effectively using the stroke simulator 69 as the hydraulic pressure source.

When priority is given to maintenance of the sufficient fail-safe properties, preferably, the control mode is changed as quickly as possible. According to the embodiment of the invention, the master cut valve 64 is opened first, and then the simulator cut valve 68 is closed. When the simulator cut valve 68 is closed, the change of the control mode is completed. Because the time at which the master cut valve 64 is opened and the time at which the simulator cut valve 68 are staggered, a predetermined time is required to change the mode. Accordingly, it is preferable to appropriately set the condition in which the SMC initially opening control is executed, the time at which the SMC 64 is opened, the time at which the SSC 68 is closed, etc. with improvement of the brake performance due to usable use of the stroke simulator pressure and the time required to change the mode taken into account. The concrete examples will be described below.

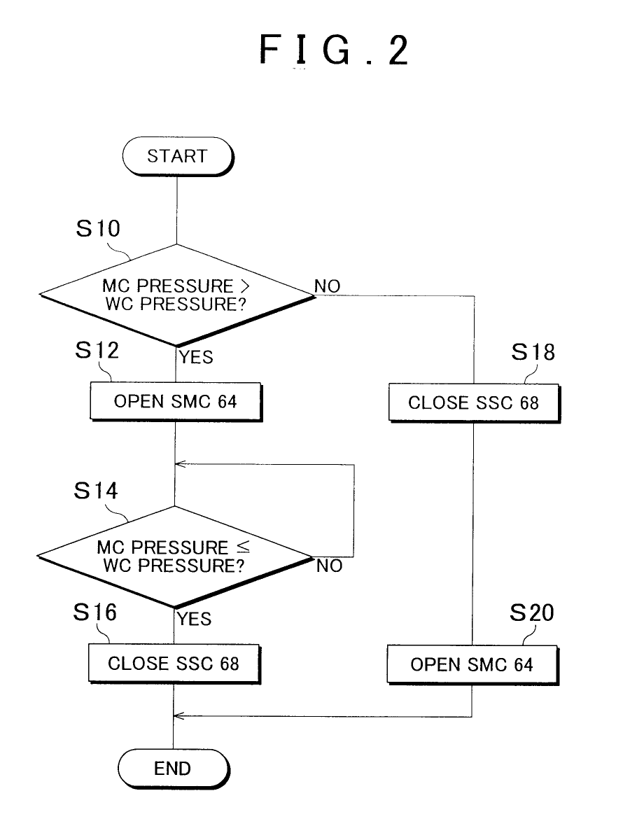

FIG. 2 shows the flowchart for describing an example of the routine executed when the control mode is changed to the static pressure mode according to the embodiment of the invention. FIG. 2 shows the routine executed by the brake ECU 70 when the control mode is changed to the static pressure mode due to, for example, detection of a malfunction. The case where the control mode is changed to the non-control mode due to detection of abnormal response of the wheel cylinder pressure to the pressure control during the regenerative cooperative control will be described below. For convenience, the master cylinder pressure is expressed as the MC pressure, and the wheel cylinder pressure is expressed as the WC pressure in FIG. 2.

When the routine shown in FIG. 2 is started, the brake ECU 70 first determines whether the master cylinder pressure is higher than the wheel cylinder pressure (S10). In the embodiment of the invention, the regulator pressure detected by the regulator pressure sensor 71 is used as the master cylinder pressure. The value detected by the control pressure sensor 73 is used as the wheel cylinder pressure.

If it is determined that the master cylinder pressure is higher than the wheel cylinder pressure (“Yes” in S10), the brake ECU 70 executes the SMC initial opening control (S12 to S16). During the cooperative braking control, the brake ECU 70 usually controls the wheel cylinder pressure so that the wheel cylinder pressure is lower than the master cylinder pressure by an amount corresponding to the magnitude of the regenerative braking force. Accordingly, the SMC initially opening control is executed usually in the routine shown in FIG. 2.

If the cooperative braking control is executed when it is determined that the control mode need to be changed to the static pressure mode, the brake ECU 70 may execute the SMC initially opening control without comparing the master cylinder pressure with the wheel cylinder pressure. This is because, the master cylinder pressure is usually higher than the wheel cylinder pressure during the cooperative braking control, as described above.

On the other hand, if it is determined that the master cylinder pressure is equal to or lower than the wheel cylinder pressure (“No” in S10), the brake ECU 70 closes the simulator cut valve 68 (S18), and opens the master cut valve 64 (S20), after which the routine ends. In this case, preferably, the simulator cut valve 68 is closed before the master cut valve 64 is opened, or the simulator cut valve 68 closed at the same time as opening of the master cut valve 64 so that the stroke simulator pressure does not affect the wheel cylinder pressure.

When the SMC initially opening control is executed, the brake ECU 70 first opens the master cut valve 64 (S12). When the routine shown in FIG. 2 is started, the simulator cut valve 68 is open. At this time, therefore, both the master cut valve 64 and the simulator cut valve 68 are open. Thus, both the master cylinder 32 and the stroke simulator 69 are communicated with the wheel cylinders 23. Immediately after the master cut valve 64 is opened, both the master cylinder pressure and the stroke simulator pressure are higher than the wheel cylinder pressure, and both the master cylinder 32 and the stroke simulator 69 serve as the sources of the hydraulic pressure that is supplied to the wheel cylinders 23. When opening the master cut valve 64, the brake ECU 70 opens the regulator cut valve 65 and closes the partition valve 60.

Next, the brake ECU 70 determines whether the master cylinder pressure is equal to or lower than the wheel cylinder pressure (S14). If it is determined that the master cylinder pressure is higher than the wheel cylinder pressure (“No” in S14), the brake ECU 70 keeps both the master cut valve 64 and the simulator cut valve 68 open. On the other hand, if it is determined that the master cylinder pressure is equal to or lower than the wheel cylinder pressure (“Yes” in S14), the brake ECU 70 closes the simulator cut valve 68 (S16), after which the routine for changing the control mode ends. As long as the predetermined condition is satisfied, the brake ECU 70 keeps the master cut valve 64 and the simulator cut valve 68 open. When the predetermined condition becomes unsatisfied, the brake ECU 70 closes the simulator cut valve 68. Usually, the master cylinder pressure decreases and approaches the wheel cylinder pressure after the master cut valve 64 is opened. When the master cylinder pressure is equal to the wheel cylinder pressure, the simulator cut valve is closed. For example, when the pressure difference between the wheel cylinder pressure and the master cylinder pressure before the master cut valve is opened is large, the master cylinder pressure may be temporarily lower than the wheel cylinder pressure.

According to the embodiment of the invention as described so far, adjusting the time at which the simulator cut valve 68 is closed and the time at which the master cut valve 64 is opened makes it possible to increase the pressure of the hydraulic fluid supplied to the wheel cylinders 23 by effectively using not only the brake fluid that remains in the master cylinder 32 but also the brake fluid used by the stroke simulator 69. Especially, when the control mode is changed to the static pressure mode during the cooperative braking control, the stroke simulator pressure is usually higher than the wheel cylinder pressure. Accordingly, the pressure accumulated in the stroke simulator is smoothly used to increase the hydraulic pressure that is applied to the wheel cylinders 23 by opening the master cut valve 64 first. Thus, it is possible to improve the brake performance offered when the control mode is changed to the static pressure mode. Also, the brake performance is improved without increasing the size of the master cylinder 32 or reducing the size of the stroke simulator 69. Accordingly, the flexibility in designing the master cylinder 32 and the stroke simulator 69 also improves.

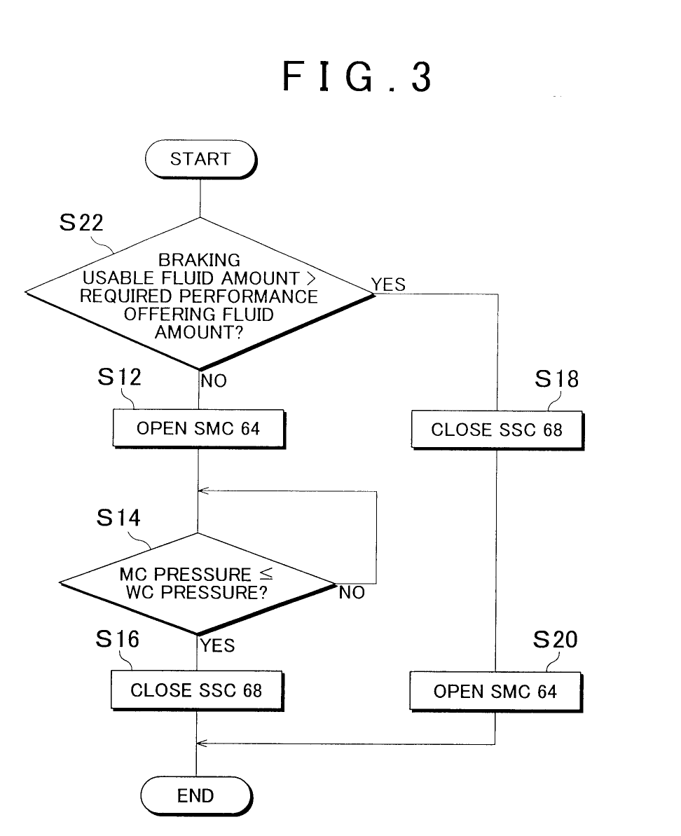

Next, modified examples of the embodiment of the invention will be described. FIG. 3 shows the flowchart for describing an example of the routine executed when the control mode is changed to the static pressure mode according to a modified example of the embodiment of the invention. In the embodiment of the invention described above, the SMC initially opening control is executed under the determination condition where the master cylinder pressure is higher than the wheel cylinder pressure (S10). However, another determination condition may be employed instead of the determination condition used in S10. For example, the brake ECU 70 may execute the SMC initially opening control when it is estimated that the predetermined brake performance cannot be offered even if the brake fluid that remains in the master cylinder is supplied to the wheel cylinders. In the following description concerning the modified examples, the same portions as those in the embodiment described above will be not be described again.

For ease of description, the amount of hydraulic fluid that remains in the master cylinder 32 will be referred to as the master cylinder residual fluid amount, and the amount of hydraulic fluid stored in the wheel cylinders 23 will be referred to as the wheel cylinder used fluid amount, where appropriate. The sum of the master cylinder residual fluid amount and the wheel cylinder used fluid amount will be referred to as the braking usable fluid amount. The amount of fluid that is delivered from the master cylinder 32 and stored in the stroke simulator 69 will be referred to as the simulator used fluid amount. The braking usable fluid amount corresponds to the maximum amount of fluid that can be used for the braking operation when the hydraulic fluid stored in the stroke simulator 69 is not used in the static pressure mode.

In the modified example, the brake ECU 70 determines whether the SMC initially opening control is executed, based on the magnitude correlation between the amount of hydraulic fluid required to offer the predetermined brake performance and the braking usable fluid amount. The predetermined brake performance may be the minimum brake performance (braking force) that must be offered even if a malfunction occurs and that is set in accordance with the low, or the brake performance (braking force) that is higher than the brake performance set in accordance with the law. The amount of hydraulic fluid required to offer the predetermined brake performance (braking force) will be referred to as the required performance offering fluid amount, where appropriate.

When the routine shown in FIG. 3 is started, the brake ECU 70 determines whether the braking usable fluid amount is greater than the required performance offering fluid amount (S22). If it is determined that the braking usable fluid amount is equal to or less than the required performance offering fluid amount (“No” in S 22), the brake ECU 70 executes the SMC initially opening control (S12 to S16). In this case, it is estimated that both of the master cylinder residual fluid amount and the wheel cylinder used fluid amount are relatively small. For example, it is estimated that the wheel cylinder pressure is low because most of the required braking force is derived from the regenerative braking force or the simulator used fluid amount is great because the operation amount of the brake pedal 24 is relatively great.

The brake ECU 70 estimates the master cylinder residual fluid amount based on the brake pedal operation amount detected by the stroke sensor 25 or the regulator pressure detected by the regulator pressure sensor 71. Alternatively, the map indicating the relationship between the master cylinder residual fluid amount and the brake pedal operation amount or the regulator pressure may be prepared and stored in the brake ECU 70 in advance, and the brake ECU 70 may calculate the master cylinder residual fluid amount based on the map. The wheel cylinder used fluid amount is calculated based on the control pressure detected by the control pressure sensor 73 or estimated based on the map. The required performance offering fluid amount is set in advance, and stored in the brake ECU 70.

On the other hand, if it is determined that the braking usable fluid amount is greater than the required performance offering fluid amount (“Yes” in S22), the brake ECU 70 closes the simulator cut valve 68 (S18), and opens the master cut valve 64 (S20), after which the routine for changing the control mode ends. In this case, it is estimated that the master cylinder residual fluid amount or the wheel cylinder used fluid amount is relatively great. For example, it is estimated that the wheel cylinder pressure is high because a great hydraulic braking force is required, or the simulator used fluid amount is small because the operation amount of the brake pedal 24 is relatively small.

The modified example is different from the embodiment described above in that, even if the master cylinder pressure is higher than the wheel cylinder pressure, the SMC initially opening control is not executed as long as the braking usable fluid amount is greater than the required performance offering fluid amount. Accordingly, as long as the braking usable fluid amount is greater than the required performance offering fluid amount, the control mode is quickly changed to the static pressure mode, which contributes to maintenance of sufficient fail-safe properties. When the braking usable fluid amount is less than the required performance offering fluid amount, the brake performance required while the control mode is changed can be offered by effectively using the stroke simulator pressure. Therefore, according to the modified example, it is possible improve the brake performance offered when the control mode is changed, as well as promptly changing the control mode.

In the description above, whether the SMC initially opening control is executed is determined by comparing the braking usable fluid amount with the required performance offering fluid amount. Alternatively, whether the SMC initially opening control is executed may be determined by comparing the master cylinder residual fluid amount with the required performance offering fluid amount. In this manner as well, the brake ECU 70 can determine whether it is impossible to offer the predetermined brake performance even if the brake fluid that remains in the master cylinder is supplied to the wheel cylinders.

In the routines shown in FIGS. 2 and 3, the brake ECU 70 determines the time at which the simulator cut valve 68 is closed after the master cut valve 64 is opened based on the magnitude correlation between the master cylinder pressure and the wheel cylinder pressure (S14). However, the manner in which the brake ECU 70 makes such determination is not limited to this. For example, the simulator cut valve open period during which the simulator cut valve 68 is kept open may be set in advance, and the brake ECU 70 may close the simulator cut valve 68 when the simulator cut valve open period has elapsed since the master cut valve 64 is opened. The simulator cut valve open period may be appropriately set based, for example, on the results of experiments with the balance between the time required to change the control mode and the effective use of the stroke simulator pressure taken into account. Thus, it is possible to effectively use the brake fluid stored in the stroke simulator 69, as well as promptly closing the simulator cut valve after the simulator cut valve open period has elapsed since the master cut valve 64 is opened to complete the change to the static pressure mode. This modified example is favorably employed when priority is given to a prompt change to the static pressure mode.

Alternatively, the simulator cut valve 68 may be kept open until the brake pedal 12 is released and it is determined that the braking operation is cancelled after the master cut valve 64 is opened. In this manner, the SMC initially opening control can be executed through relatively simple control.

According to the embodiment of the invention, it is possible to use the smaller master cylinder 32 which has a smaller fluid storage capacity because the hydraulic fluid in the simulator is available. When the wheel cylinder pressure that is required to offer the required brake performance is X (MPa), the total fluid storage capacity of the master cylinder 32 is set to the sum of the wheel cylinder used fluid amount when the wheel cylinder pressure is X (MPa) and the simulator used fluid amount when the stroke simulator pressure is X (MPa). If the stroke of the master cylinder piston and the diameter of the master cylinder 32 are set so that the total fluid storage capacity of the master cylinder 32 is equal to the sum, the minimum sized master cylinder that offers the required performance is provided.

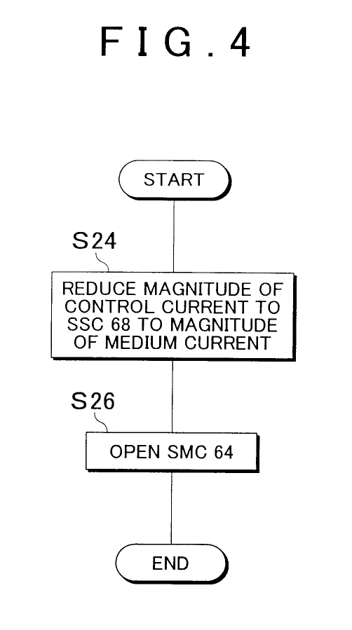

Next, another modified example of the embodiment of the invention will be described. FIG. 4 is the flowchart for describing an example of the routine executed when the control mode is changed to the static pressure mode. In the embodiment of the invention, until the simulator cut valve 68 is closed, the current having the prescribed magnitude is supplied to the simulator cut valve 68 so that the simulator cut valve 68 is kept open. However, according to the modified example, the brake ECU 70 supplies the medium current that is smaller in magnitude than the control current to the simulator cut valve 68 when the master cut valve 64 is opened. Appropriately setting the magnitude of the medium current makes it possible to mechanically close the simulator cut valve 68 when the pressure difference between the upstream side and the downstream side of the simulator cut valve 68 is equal to the predetermined pressure corresponding to the medium current. In the description concerning the modified example, the same portions as those in the above-described embodiment will not be provided again.

The brake ECU 70 executes the routine shown in FIG. 4 when the control mode is changed to the static pressure mode. When the routine is started, the brake ECU 70 decreases the magnitude of the control current supplied to the simulator cut valve 68 to the predetermined magnitude of medium current (S24). The magnitude of the medium current is set so that the simulator cut valve 68 is closed when the pressure difference between the upstream side and the downstream side of the simulator cut valve 68 is zero. In this case, the magnitude of the medium current is set so that the balance between the elastic force of the return spring embedded in the simulator cut valve 68 and the electromagnetic valve opening force generated by the coil using the medium current is maintained. Thus, the simulator cut valve 68 is automatically closed when the master cylinder pressure is equal to the stroke simulator pressure.

The brake ECU 70 reduces the control current supplied to the simulator cut valve 68 and opens the master cut valve 64 (S26). Thus, the change of the control mode to the static pressure mode is completed in the control. In the actual operation, the change in the control mode to the static pressure mode is completed when the simulator cut valve 68 is mechanically closed due to a decrease in the stroke simulator pressure. Then, the brake ECU 70 may stop the supply of the medium current to the simulator cut valve 68 when the brake pedal 24 is released and it is determined that the braking operation is cancelled, or when the predetermined time period has elapsed since the medium current starts to be supplied to the simulator cut valve 68.

According to the modified example, it is possible to execute the SMC initially opening control through simple control for reducing the magnitude of the control current to that of the medium current. The SMC initially opening control can be executed even if a malfunction occurs in a sensor, because the measured values obtained by, for example, a pressure sensor are not used in the control.

When priority is given to the effective use of the stroke simulator pressure, preferably, the magnitude of the medium current is set so that the simulator cut valve 68 is closed when the pressure difference between the upstream side and the downstream side of the simulator cut valve 68 is zero, as described above. When priority is given to the prompt change of the control mode to the static pressure mode, preferably, the magnitude of the medium current is adjusted so that the simulator cut valve 68 is mechanically closed even if there still remains some pressure difference between the upstream side and the downstream side of the simulator cut valve 68.

The invention operates not only during the cooperative braking control. For example, the invention may also operate during the linear control mode where the cooperative braking control is not executed, if the wheel cylinder pressure decreases due to leakage of the hydraulic fluid from the rear wheel side. In such a case as well, the brake performance offered when the control mode is changed to the static pressure mode is improved by effectively using the brake fluid used in the stroke simulator.

What is claimed is:

1. A brake control apparatus, comprising:
a master cylinder that pressurizes a hydraulic fluid in accordance with an operation amount of a brake operating member and then delivers the pressurized hydraulic fluid;
a stroke simulator that generates a reaction force against an operation on the brake operating member when supplied with the hydraulic fluid delivered from the master cylinder;
wheel cylinders that apply braking force to respective wheels when supplied with the hydraulic fluid delivered from the master cylinder; and
a controller that controls a manner in which the hydraulic fluid is delivered,
wherein, when a destination of the hydraulic fluid from the master cylinder is changed from the stroke simulator to the wheel cylinders to start increasing a wheel cylinder pressure which is a pressure of the hydraulic fluid supplied to the wheel cylinders, the controller controls the manner in which the hydraulic fluid is delivered so that the stroke simulator is used in combination with the master cylinder as a hydraulic pressure source.

2. The brake control apparatus according to claim 1, further comprising:
a simulator cut valve that is provided in a passage which connects the master cylinder to the stroke simulator; and
a master cut valve that is provided in a passage which connects the master cylinder to the wheel cylinders,
wherein the controller opens the master cut valve before closing the simulator cut valve when the destination of the hydraulic fluid from the master cylinder is changed from the stroke simulator to the wheel cylinders.

3. The brake control apparatus according to claim 2, wherein the controller opens the master cut valve with the simulator cut valve kept open when a predetermined condition is satisfied, and the controller keeps the simulator cut valve open as long as the predetermined condition is satisfied.

4. The brake control apparatus according to claim 3, wherein the predetermined condition is a condition that the master cylinder pressure is higher than the wheel cylinder pressure.

5. The brake control apparatus according to claim 2, wherein:
the simulator cut valve is a normally closed electromagnetically controlled valve that is reliably kept open by an electromagnetic force which is generated when the simulator cut valve is supplied with a control current having a prescribed magnitude, and that is closed while the simulator cut valve is not supplied with the control current; and
the controller supplies a medium current having a smaller magnitude than the control current to the simulator cut valve when the master cut valve is opened.

6. The brake control apparatus according to claim 5, wherein
the controller sets the magnitude of the medium current so that the simulator cut valve is closed when a pressure difference between an upstream side and a downstream side of the simulator cut valve is zero.

7. The brake control apparatus according to claim 2, wherein the controller closes the simulator cut valve when a predetermined time period has elapsed since the master cut valve is opened.

8. The brake control apparatus according to claim 1, wherein, when a master cylinder pressure, which is a pressure generated by the master cylinder, is higher than the wheel cylinder pressure, the controller controls the manner in which the hydraulic fluid is delivered so that the stroke simulator is used in combination with the master cylinder as the hydraulic pressure source.

9. The brake control apparatus according to claim 1, wherein, when it is estimated that predetermined brake performance cannot be offered even if the hydraulic fluid that remains in the master cylinder is supplied to the wheel cylinders, the controller controls the manner in which the hydraulic fluid is delivered so that the stroke simulator is used in combination with the master cylinder as the hydraulic pressure source.

10. The brake control apparatus according to claim 1, wherein the controller controls the manner in which the hydraulic fluid is delivered by interrupting communication between the master cylinder and the stroke simulator after permitting communication between the master cylinder and the wheel cylinders.

11. A brake control method, comprising:
providing a master cylinder that pressurizes a hydraulic fluid in accordance with an operation amount of a brake operating member and then delivers the pressurized hydraulic fluid; a stroke simulator that generates a reaction force against an operation on the brake operating member when supplied with the hydraulic fluid delivered from the master cylinder; and wheel cylinders that apply braking force to respective wheels when supplied with the hydraulic fluid delivered from the master cylinder; and
controlling a manner in which the hydraulic fluid is delivered so that the stroke simulator is used in combination with the master cylinder as a hydraulic pressure source, when a destination of the hydraulic fluid from the master cylinder is changed from the stroke simulator to the wheel cylinders to start increasing a wheel cylinder pressure which is a pressure of the hydraulic fluid supplied to the wheel cylinders.
